(19) United States
(12) Patent Application Publication
(10) Pub. No.: US 2025/0298803 A1
(43) Pub. Date: Sep. 25, 2025

(54) SYSTEM AND METHOD FOR GENERATING A TAGGED COLUMN-ORIENTED DATA STRUCTURE

(71) Applicant: Monday.com Ltd., Tel Aviv (IL)

(72) Inventors: Arnon NIR, Tel Aviv (IL); Roy MANN, Tel Aviv (IL); Eran ZINMAN, Tel Aviv (IL); Tal HARAMATI, Tel Aviv (IL)

(73) Assignee: Monday.com Ltd., Tel Aviv (IL)

(21) Appl. No.: 19/229,423

(22) Filed: Jun. 5, 2025

Related U.S. Application Data
(63) Continuation of application No. 16/519,667, filed on Jul. 23, 2019, now Pat. No. 12,353,419.
(60) Provisional application No. 62/701,907, filed on Jul. 23, 2018.

(51) Int. Cl. G06F 16/2455; G06F 16/22; G06F 16/25

(52) U.S. Cl. CPC G06F 16/24564; G06F 16/221; G06F 16/258

(57) ABSTRACT

A system and method for generating tagged column-oriented data structures, including: generating a column-oriented data structure that comprises a plurality of columns, wherein each column comprises a plurality of cells that are associated with a single data type, wherein at least one of the plurality of columns is a tag type column; and inserting at least one tag into a first cell of the tag type column, where the first cell further associated with a first row of cells.

### CROSS-REFERENCE TO RELATED APPLICATIONS

This application claims the benefit of U.S. Provisional Application No. 62/701,907 filed on Jul. 23, 2018, the contents of which are hereby incorporated by reference.

### TECHNICAL FIELD

The present disclosure relates generally to column-oriented data structures analysis and more particularly, to a system and method thereof for generating tagged datasets in a column-oriented data structure.

### BACKGROUND

In today's world, large enterprises, as well as small and medium-size enterprises, must deal with the challenge of managing their operations. The task of managing operations may be complicated and time consuming. In many cases, managing operations of a single project requires integration of several employees, departments, and the like of the entity.

In order to deal with this complicated and time-consuming task, many entities use different project management software applications. These software applications allow for the organizing, planning and managing of resources in order to optimize the time and resources spent on each project. Some of these software applications can manage estimation and planning, scheduling, cost control and budget management, communication, decision making, and so on.

One of the most valuable features of management applications is the ability to provide information regarding one or more projects in real time. Such information may include for example, overview on how long tasks will take to complete, early warning of any risks to the project, historical information on how projects have progressed, how actual and planned performance are related, cost maintenance, etc.

Although these software applications allow their users to overcome many challenges in managing their projects, the searching capabilities offered to allow a user to filter and aggregate desirable data elements associated with one or more projects could be improved, as they are often inefficient and fail to provide a quick method of showing only relevant data.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a method for generating tagged column-oriented data structures, comprising: generating a column-oriented data structure that comprises a plurality of columns, wherein each column comprises a plurality of cells that are associated with a single data type, wherein at least one of the plurality of columns is a tag type column; and inserting at least one tag into a first cell of the at least one tag type column, wherein the first cell is further associated with a first row of cells.

Certain embodiments disclosed herein also include a non-transitory computer readable medium having stored thereon instructions for causing a processing circuitry to perform a process, the process comprising: generating a column-oriented data structure that comprises a plurality of columns, wherein each column comprises a plurality of cells that are associated with a single data type, wherein at least one of the plurality of columns is a tag type column; and, inserting at least one tag into a first cell of the at least one tag type column, wherein the first cell is further associated with a first row of cells.

Certain embodiments disclosed herein also include a system for generating tagged column-oriented data structures, comprising: a processing circuitry; and a memory, the memory containing instructions that, when executed by the processing circuitry, configure the system to: generate a column-oriented data structure that comprises a plurality of columns, wherein each column comprises a plurality of cells that are associated with a single data type, wherein at least one of the plurality of columns is a tag type column; and, insert at least one tag into a first cell of the at least one tag type column, wherein the first cell is further associated with a first row of cells.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a block diagram of a computing device for generating a tagged column-oriented data structure according to an embodiment.

FIG. 2 is a network diagram of a computing architecture utilized to describe the various embodiments disclosed herein.

FIG. 3 is a flowchart illustrating a method for generating a column-oriented data structure with a tag type column according to an embodiment.

FIG. 4 is flowchart illustrating a method for inserting a new tag into a tag type column in column-oriented data structures according to an embodiment.

FIGS. 5A and 5B are example schematic diagrams that demonstrates filtering datasets in column-oriented data structures according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for generating a tagged column-oriented data structure. The system is configured to generate a column-oriented data structure that includes columns, where the columns contain cells associated with a single data type, such as a numeric data type column, an alphanumeric data type column, a percentages data type column, and so on. At least one of the columns is a tag type column adapted to contain therein at least one cell that comprises one or more tags. The system inserts one or more tags into a first cell of the tag type column. The tags of the first cell are associated with data elements stored within a plurality of cells of a first row of cells. The disclosed embodiment includes the generation of single data type column-oriented data structures having at least one tag type column, allowing for rapidly locating data elements within the plurality of column-oriented data structures. The use of a single data type column-oriented data structure allows users to insert only the values that have been predetermined as valid, prevent typos, and the like.

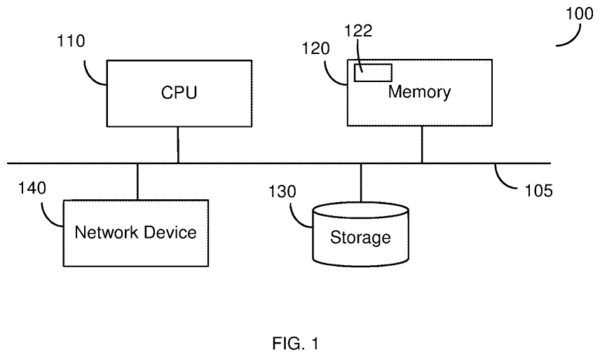

FIG. 1 shows an exemplary and non-limiting block diagram of a computing device 100 for generating a tagged column-oriented data structure according to an embodiment. The computing device 100 includes at least one processing element 110, for example, a central processing unit (CPU) or similar processing circuitry. In an embodiment, the processing element 110 includes, or is a component of, a larger processing unit implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information. The CPU 110 is coupled via a bus 105 to a memory 120.

The memory 120 further includes a memory portion 122 that contains instructions that, when executed by the processing element 110, performs the method described in more detail herein. The memory 120 may be further used as a working scratch pad for the processing element 110, a temporary storage, and others, as the case may be. The memory 120 may be a volatile memory such as, but not limited to, random access memory (RAM), or non-volatile memory (NVM), such as, but not limited to, flash memory.

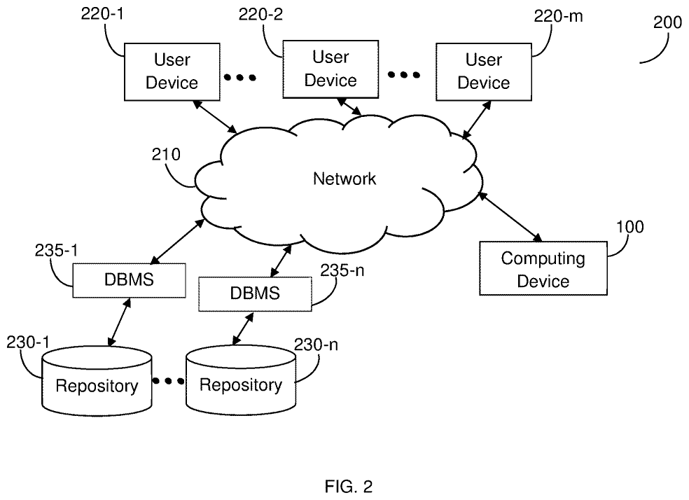

The processing element 110 may be further connected to a network device 140, such as a network interface card, for providing connectivity between the computing device 100 and a network, such as a network 210 discussed in more detail with respect to FIG. 2. The processing element 110 may be further connected to a storage 130. The storage 130 may be used for the purpose of storing single data type column-oriented data structures, data elements associated with the single data type column-oriented data structures, and so on.

The processing element 110 or the memory 120 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions cause the processing element 110 to perform the various functions described in further detail herein.

FIG. 2 is a network diagram of a computing architecture 200 utilized to describe the various embodiments disclosed herein. The computing device 100 is connected to the network 210. The computing device 100 and its components are described in more detail with respect of FIG. 1. The network 210 enables communication between different elements that may be connected to the computing device 100, as further described herein below. The network 210 may be the Internet, the world-wide-web (WWW), a local area network (LAN), a wide area network (WAN), a metro area network (MAN), and other networks capable of enabling communication between the elements of the computing architecture 200. In an embodiment, the computing device 100 is a server deployed in a cloud computing environment.

One or more user devices 220-1 through user device 220-m, where m is an integer equal to or greater than 1, referred to individually as user device 220 and collectively as user devices 220, may be connected to the computing device 100 via the network 210. A user device 220 may be, for example, a smart phone, a mobile phone, a laptop, a tablet computer, a wearable computing device, a personal computer (PC), a smart television and the like.

A user device 220 may be configured to send to and receive from the computing device 100 data and/or metadata associated with a variety of elements associated with single data type column-oriented data structures, such as columns, rows, cells, schemas, and the like. One or more data repositories 230-1 through data repository 230-n, where n is an integer equal to or greater than 1, referred to individually as data repository 230 and collectively as data repositories 230, may be connected to the computing device 100 via the network 210, or embedded within the computing device 100.

The data repository 230 may be, for example, a storage device containing thereon a database, a data warehouse, and the like, that may be used for storing data structures, data items, metadata, and the like, as further described herein below. In some embodiments, one or more of the repositories may be distributed over several physical storage devices e.g., in a cloud-based computing environment. Any of the storage devices may be a network accessible storage device, or a component of the computing device 100.

According to an embodiment, the computing device 100 may be configured to generate a column-oriented data structure. The column-oriented data structure includes a plurality of columns. Each column includes a plurality of cells and each column is associated with a single data type. A single data type column is one where all cells are uniform in at least one aspect. The aspect may be that the column contain numeric values only, characters only, alphanumeric values only, graphic elements only, a closed list of elements, particular formatting, values within the range of 1-100 only, values within the range of “A” to “E” only, and so on.

At least one of the plurality of columns of the column-oriented data structure is a tag type column. A tag type column is a column having one or more cells that include therein one or more tags. The tags may be for example, a label, a numeric value, a title, a name, a combination thereof, and so on, used to easily identify a descriptive quality of data within the column-oriented data structure.

The computing device 100 is further configured to insert one or more tags, in response to receiving a request from one or more user devices 220, into a first cell of the tag type column using for example, a database management service (DBMS) 235. The tags may be received from a user device 220-1 that is associated with a first user account. The first cell may be further associated with a first row of cells. Thus, the one or more tags of the first cell of the tag type column may be indicative of data items stored in a row, i.e., a first row that intersects the first cell of the tag type column.

For example, a first tag entitled “Projects 2018” is stored in a cell that crosses the third row of the column-oriented data structure. According to the same example, other cells positioned in the same third row in different columns contain the name of the project manager, the design status, the research and development (R&D) status, etc. According to the same example, it may be desirable to add a tag titled “Projects 2018” to every project that has been initiated in 2018 such that it will be easy for a user to track these projects. It should be noted that this is only one example of many processes that can be tagged and tracked using the computing device 100. A system displaying a table of the column-oriented data structure may apply a filter to certain rows within the column-oriented data structure according to the tags. This allows for the displaying of information in a way which is more easily consumed and understood by users of the system. For example, all rows that do not contain a specific tag may be hidden from view such that only the rows having that specific tag are shown.

According to an embodiment, the generation of the column-oriented data structure is executed by the computing device 100 in response to receiving a request for generating the column-oriented data structure by the computing device 100. The request may be received by the computing device 100 from one or more of the user devices 220.

According to another embodiment, the computing device 100 may be configured to automatically generate the tags by identifying at least one data item stored in at least a second cell of the first row of cells that is associated with at least a column that a non-tag type column. Based on the identification, the computing device 100 may be configured to generate one or more tags associated with the identified at least one data item. The automated tag generation may be achieved using a predetermined set of rules. The predetermined set of rules may indicate, for example, that when a certain name of an employee, manager, supervisor, and so on, exists in a row, a tag associated with the name of the person is generated.

According to another embodiment, the one or more tags may be stored in the storage 130 or in the data repository 230 such that when a request for retrieving data associated with a specific tag is received by the computing device 100, the tag is searched in the storage 130 or the data repository 230 for identifying the location of the tag. Each tag may be positioned within multiple cells associated with tag type columns that may be located in one or more column-oriented data structures, in one or more schemas, cell arrays, and the like. For example, each row may be associated with an index number, and each tag associated with the index numbers of the rows in which the tag appears in a cell of a tag column.

According to yet another embodiment, the computing device 100 is configured to receive a query associated with a first tag for filtering a plurality of data elements stored in a certain column-oriented data structure. Upon receiving the query, the computing device 100 is configured to analyze the query for identifying at least one keyword associated with a predetermined first tag. After the first tag, i.e., a keyword, is identified, the computing device 100 aggregates a corresponding dataset, e.g. a table that includes rows that are associated with the tag, and displays the aggregated datasets. The aggregated datasets may be caused to be displayed on a user device 220. In an embodiment, the query may include one or more tags.

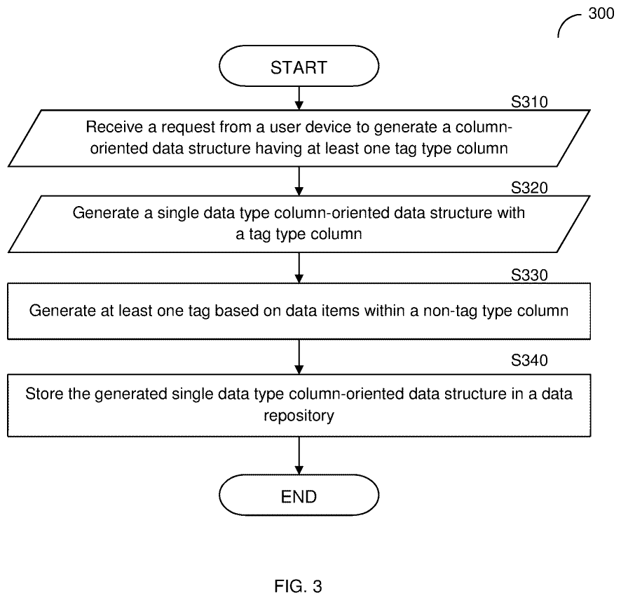

FIG. 3 is an example flowchart 300 illustrating a method for generating a column-oriented data structure with a tag type column according to an embodiment.

At S310, a request for generating a single data type column-oriented data structure (hereinafter: a table) having at least one tag type column is received, e.g., by the computing device 100 of FIG. 1. The request may be received from a user device 220.

At S320, the table is generated. The table includes a plurality of single data type columns as well as a plurality of rows. A single data type column is a column where all cells are uniform in at least one aspect. The aspect may be that the cells contain numeric values only, characters only, alphanumeric values, graphic elements only, a closed list of elements, specific formatting, values within the range of 1-100 only, values within the range of “A” to “E” only, and so on. Each single data type column includes a plurality of cells.

At least one of the plurality of columns of the table is a tag type column. A tag type column includes one or more cells that include therein one or more tags. The tags may be for example, a label, a numeric value, a title, a name, a combination thereof, and so on. In an embodiment, the tags may be used to easily identify a descriptive quality of data within the column-oriented data structure.

At S330, at least one tag is generated based on data items within a non-tag type column. The tag is generated by identifying at least one data item stored in at least a second cell of a row of cells that is associated with at least a non-tag type column. Based on the identification, one or more tags associated with the identified at least one data item is generated. The automated tag generation may be achieved using a predetermined set of rules. The predetermined set of rules may indicate, for example, that when a certain name of an employee, manager, supervisor, and so on, exists in a row, a tag associated with the name of that person is generated.

At S340, the generated table including the at least one tag type column and the generated at least one tag is stored, e.g., in a storage 130 for future reference. In an embodiment, the generated table may be stored in a data repository 230.

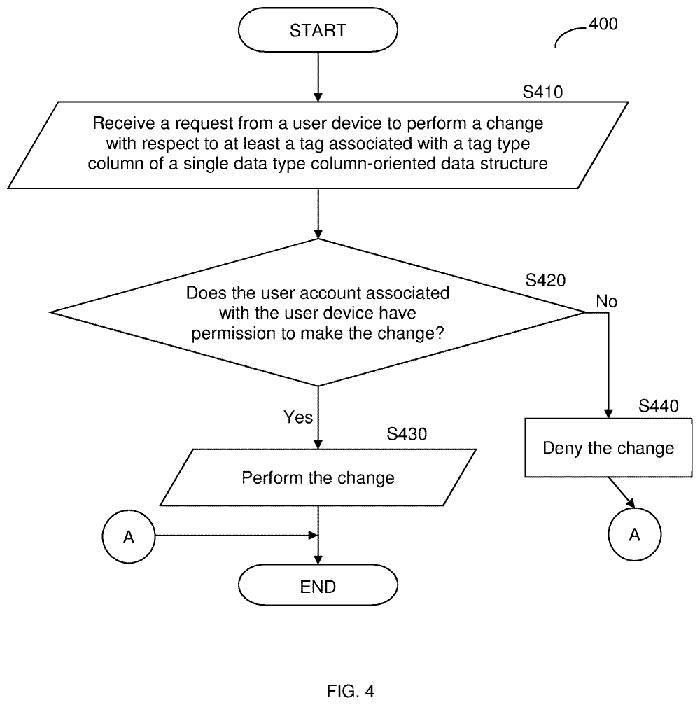

FIG. 4 is an example flowchart 400 illustrating a computerized method for inserting a new tag into a tag type column in column-oriented data structures according to an embodiment.

At S410, a request for performing a change with respect to at least a tag associated with a tag type column of a single data type column-oriented data structure (hereinafter: a table) is received, e.g., from a user device 220. The request may require adding a tag, deleting a tag, change a tag location, adding a tag type column to a table, and the like. For example, a first user account associated with a first user device, e.g., user device 220-1 of FIG. 2, may have all permissions available with respect to tag type columns. According to the same example, a second user account that is associated with a second user device, e.g., user device 220-2 of FIG. 2, may have only permission to perform a search using the tags, but not permission to add new tags, delete tags, change the tags' location, etc.

At S420, it is determined whether the requesting source, e.g., user device 220, has permission to make the change, and if so execution continues with S430, otherwise; execution continues with S440. The set of permissions of the specific data structure may be indicative of whether the user device has the permission to make the desired change or not. In an embodiment, S420 may further include identifying the required change, i.e., the change type. Thus, what kind of action the user device associated with a certain user account, is trying to perform is determined. According to one embodiment, S420 may further include searching for a set of permissions associated with the user account associated with the user device from which the request was received, with respect to the table that includes the at least one tag type column. Permissions are predetermined rights allowing a user account to make one or more actions such as, adding tags, deleting tags, changing tags' location, and so on. The permissions may be allocated to a user account that is associated with a user device, a plurality of user devices associated with a certain entity such as a department, and the like.

At S430, the requested change is performed in the data structure.

At S440, in response to determining that the user account that is associated with the requesting user device does not have permission to make the desired change, the request for the change is denied.

According to one embodiment, same tags may be used in different data structures associated with public boards, private boards, shareable boards, and so on. A public board is a data structure that is accessible to any user, a private board is a data structure that is accessible only to users having a certain permission, and sharable board is a data structure that includes a plurality of permissions where each permission is associated with a specific user or user device. The sharable board may be initiated by a first user that is associated with, for example, a company, and then the sharable board may be shared with a second user that is not part of the company.

According to another embodiment, in response to receiving a query, e.g., a request to search for specific data associated with the tag “Dan” in a first private board, data associated with the tag “Dan” may be retrieved only from the first private board. That is to say, where there are a plurality of tags entitled “Dan” in multiple private boards, a user associated with a certain private board can see only the “Dan” tag, and its associated data, associated with the private boards to which the user has access. According to another embodiment, when query is received to search for the tag “Dan”, in a first private board from a user device having permission to access the first private board, and the “Dan” tag exists in both the first private board and in a public board, the result of the search may include the tag “Dan” associated with the first private board and the public board.

According to another embodiment, each tag may have characteristics such as different colors, fonts, and the like, that may allow a user to easily distinguish between two tags. Thus, a received query searching for a certain tag may include different characteristics, such as the tag “Projects 2018” in a green highlight color.

According to another embodiment, when a request for renaming a certain tag associated with a public board is received, and the requesting user account is allowed to make the change and the tag is renamed with respect to the public board. However, when a request for renaming a certain tag associated with a private board is received, and the requesting user account is allowed to make the change, the tag is renamed with respect to the specific private board only.

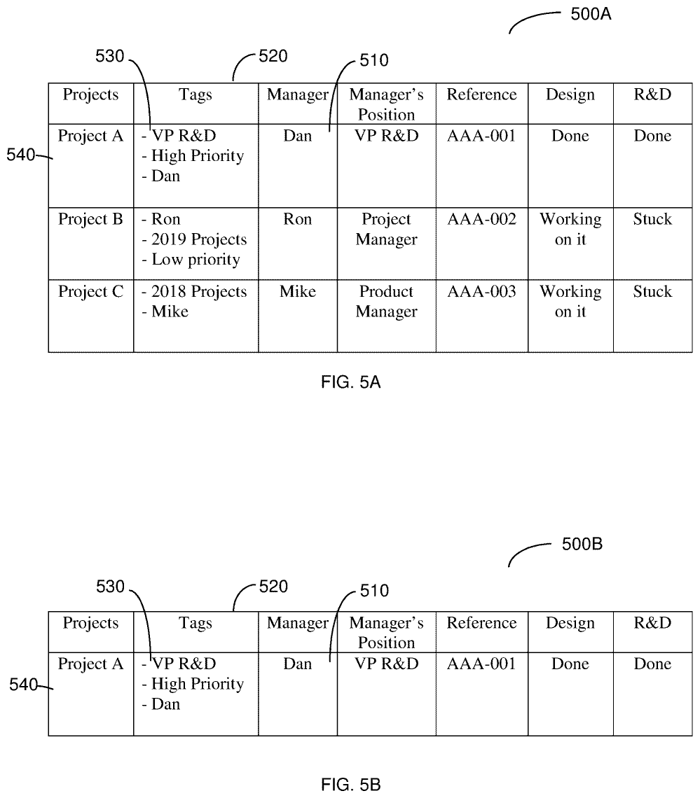

FIGS. 5A and 5B are example schematic diagrams that demonstrates tagged column-oriented data structures according to an embodiment. In FIG. 5A, an example single data type data structure 500A includes four rows and seven columns. All seven columns contain cells, such that all cells of each column are associated with a single data type (i.e., all cells of the first column are of a first data type, all cells of the second column are of a second data type, etc.). In an embodiment, certain columns can be of the same data type. For example, cell 510 in which the name “Dan” is displayed, may comprise a different name. However, a numeric value cannot be inserted into that cell.

Column 520 is a tag type column. The column 520 comprises three cells that comprise datasets, i.e., content, and one header that comprises the word “Tags”. Cell 530 lies within both the “Tags” column 520 and row 540 which relates to “Project A.” Row 540 includes several non-tag type cells, a first such cell indicates that the manager of Project A is Dan, a second cell that indicates that Dan is the vice president of research and development (VP R&D) of the organization, a third cell that indicates that the reference number of the project is AAA-001, and fourth and fifth cells that indicate that the design process as well as the R&D process are done.

As further described herein above, cell 530 is included in row 540 and column 520, such that the tags exist within cell 530 are associated with and refer to the datasets included within the cells of row 540. The tags may be identical or similar to the dataset within the cells, e.g., the tags “Dan” and “VP R&D” may exist in cell 530. According to another embodiment the tags may not be similar or identical to the datasets such as the tag “High Priority” exists in cell 530. The tag “High Priority”, once inserted into the data structure, row, etc., allows a user to search the phrase “High Priority,” applying the specific tag to a large amount of data structures and efficiently display all results, i.e., data structures, that include this tag on the user device 130 by only accessing an displaying appropriately tagged rows. It should be noted that the rest of the cells displayed are shown only for better understanding the context of the disclosure.

FIG. 5B shows a filtered dataset in a column-oriented data structure according to an embodiment. Row 540 refers to “Project A” and includes the tag “High Priority” that is located within the tag type column associated with row 540. According to an embodiment, a query including the phrase “High Priority” may be received from a user device, such as the user device 220-1 of FIG. 1. In response to receiving the query, i.e., a request to search for specific data associated with the tag “High Priority”, data associated with the tag is extracted and a table is generated to display only the relevant data as stored in the data structure. It should be noted that in FIG. 5A above there are rows that do not include a “High Priority” tag and therefore, after a request to display only projects classified as “High Priority”, row 540 is displayed alone, as shown in FIG. 5B.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for generating tagged column-oriented data structures, comprising: generating a column-oriented data structure that comprises a plurality of columns,
wherein each column comprises a plurality of cells that are associated with a single data type, wherein at least one of the plurality of columns is a tag type column; and
inserting at least one tag into a first cell of the at least one tag type column, wherein the first cell is further associated with a first row of cells.

2. The method of claim 1, further comprising:
identifying at least one data item stored in at least a second cell of the first row of cells, wherein the at least a second cell is associated with at least a column that is a non-tag type column; and,
generating the at least one tag based on the identified at least one data item.

3. The method of claim 2, wherein the at least one tag is generated using the non-tag type column based on a predetermined set of rules.

4. The method of claim 1, wherein inserting the at least one tag is performed only when a request for inserting the at least one tag is received from a requesting source having permission to insert a tag into the column-oriented data structure.

5. The method of claim 1, further comprising: receiving a query including at the least one tag; and
generating a filtered column-oriented data structure only displaying rows relevant to the at least one tag.

6. The method of claim 5, further comprising:
causing the generated filtered column-oriented data structure to be displayed on a user device.

7. The method of claim 1, wherein each of the plurality of columns is a column where all cells are uniform in at least one aspect.

8. A non-transitory computer readable medium having stored thereon instructions for causing a processing circuitry to perform a process, the process comprising:
generating a column-oriented data structure that comprises a plurality of columns, wherein each column comprises a plurality of cells that are associated with a single data type, wherein at least one of the plurality of columns is a tag type column; and,
inserting at least one tag into a first cell of the at least one tag type column, wherein the first cell is further associated with a first row of cells.

9. A system for generating tagged column-oriented data structures, comprising: a processing circuitry; and
a memory, the memory containing instructions that, when executed by the processing circuitry, configure the system to:
generate a column-oriented data structure that comprises a plurality of columns, wherein each column comprises a plurality of cells that are associated with a single data type, wherein at least one of the plurality of columns is a tag type column; and,
insert at least one tag into a first cell of the at least one tag type column, wherein the first cell is further associated with a first row of cells.

10. The system of claim 9, wherein the system is further configured to:
identify at least one data item stored in at least a second cell of the first row of cells, wherein the at least a second cell is associated with at least a column that is a non-tag type column; and,
generate the at least one tag based on the identified at least one data item.

11. The system of claim 10, wherein the at least one tag is generated using the non-tag type column based on a predetermined set of rules.

12. The system of claim 9, wherein inserting the at least one tag is performed only when a request for inserting the at least one tag is received from a requesting source having permission to insert a tag into the column-oriented data structure.

13. The system of claim 9, wherein the system is further configured to:
receive a query including at least one tag; and
generate a filtered column-oriented data structure only displaying rows relevant to the at least one tag.

14. The system of claim 13, wherein the system is further configured to:
cause the filtered generated column-oriented data structure to be displayed on a user device.

15. The system of claim 9, wherein each of the plurality of columns is a column where all cells are uniform in at least one aspect.
